(19) United States
(12) Patent Application Publication
(10) Pub. No.: US 2013/0174801 A1
(43) Pub. Date: Jul. 11, 2013

(54) VEHICULAR STARTER SOLENOID

(71) Applicant: Shihwen Chan, Downey, CA (US)

(72) Inventor: Shihwen Chan, Downey, CA (US)

(21) Appl. No.: 13/738,362

(22) Filed: Jan. 10, 2013

Related U.S. Application Data
(60) Provisional application No. 61/585,606, filed on Jan. 11, 2012.

(51) Int. Cl. F02N 15/00

(52) U.S. Cl. CPC F02N 15/00
USPC 123/179.3; 29/825

(57) ABSTRACT

Described embodiments include an aftermarket solenoid for a starting system of a vehicle. The solenoid includes a relay. The solenoid also includes an insulating cap with first and second control terminals, and first and second starter circuit terminals protruding through the cap. A control voltage between the first and second control terminals determines the resistance between the first and second starter circuit terminals, essentially creating a short between the starter circuit terminals in response to energizing the relay. Each of the terminals may he a threaded stud. The cap, the first control terminal, the second control terminal, the first starter circuit terminal, and the second starter circuit terminals are arranged so that the solenoid is pluggable into an original manufacturer wiring harness of the vehicle, avoiding the need for makeshift adjustments and modifications of various connections and/or of the original wiring harness of the vehicle.

### CROSS-REFERENCE TO RELATED APPLICATION

The present application claims priority from U.S. Provisional Patent Application Ser. No. 61/585,606, entitled VEHICULAR STARTER SOLENOID, tiled on 11 Jan. 2012, which provisional application is hereby incorporated by reference in its entirety as if fully set forth herein, including text, figures, claims, tables, computer program listing in appendices, matter incorporated by reference, and all other matter in the provisional patent application.

### FIELD OF THE INVENTION

This document relates to the field of vehicular engine starter solenoids, and particularly to aftermarket replacement solenoids.

### BACKGROUND

An internal combustion engine is commonly started by an electrical starter motor. The starter motor for simply a “starter”) is powered by a battery, usually connected to the starter through a solenoid. The solenoid is typically controlled by the user through a starter pushbutton or an ignition key.

To operate the starter, the user can press the starter pushbutton or turn the ignition key to the “start.” position, The user's action applies power to the control terminal(s) of the solenoid, which in response creates a low resistance path between two of the solenoid's output terminals (“starter circuit” terminals). The electrical circuit connecting the battery to the starter thus closes and the starter operates to start the engine.

Sometimes, it is desirable to replace an original equipment manufacturer (“OEM”) solenoid in a given vehicle. This may result, for example, from failure of the OEM solenoid, or a need for a different solenoid to operate with a replacement starter. The requirements applicable to the replacement solenoid may differ from the requirement that the OEM solenoid was designed meet. When the OEM starter is replaced by a high performance starter, for example, the operational (electrical) requirements placed on the solenoid may differ; similarly, the physical dimensions and mechanical mounting features May also change.

A need in the art exists to facilitate installation of replacement (e.g., non-OEM) solenoids with replacement solenoids.

### SUMMARY

Embodiments described throughout this document include an aftermarket solenoid. for a starting system of a vehicle. The solenoid includes an electrical switch, for example, a relay. The solenoid also includes an insulating cap with four terminals protruding therethrough: a first control terminal, a second control terminal, a first starter circuit terminal, and a second starter circuit terminal. A control voltage between the first and second control terminals determines the resistance between the first and second starter circuit terminals, essentially creating a short between the starter circuit terminals in response to energizing the switch/relay. Each of the terminals may be a threaded stud. The cap, the first control terminal, the second control terminal, the first starter circuit terminal, and the second starter circuit terminals are arranged so that the solenoid is pluggable into an original manufacturer wiring harness of the vehicle, avoiding the need for makeshift adjustments and modifications of various connections and/or the original wiring harness of the vehicle.

In an embodiment, an aftermarket solenoid for a vehicular starting system for a vehicle includes an electrical switch, an insulating cap, a first control terminal, a second control terminal, a first starter circuit terminal, and a second starter circuit terminal. A control voltage between the first and second control terminals determines resistance path between the first and second starter circuit terminals. The first control terminal may be a first threaded stud protruding through the cap, the second control terminal may be a second threaded stud protruding through the cap, the first starter circuit terminal may be a third threaded stud protruding through the cap, and the second starter circuit terminal may be a fourth threaded stud protruding through the cap. The cap, the first control terminal, the second control terminal, the first starter circuit terminal, and the second starter circuit terminal are arranged so that the aftermarket solenoid is pluggable into an original equipment manufacturer wiring harness of the vehicle. The aftermarket solenoid may be configured to operate an offset gear reduction starter that includes a gear configured to engage selectively an engine of the vehicle.

In an embodiment, a starter assembly may he made with the aftermarket solenoid in combination with a mounting bracket and the offset gear reduction starter electrically coupled to the aftermarket solenoid so that the offset gear reduction starter is controlled by the aftermarket solenoid. The offset gear reduction starter and the aftermarket solenoid may be attached to the mounting bracket so that the assembly is configured for installation in the vehicle to allow simultaneously (1) the gear of the offset gear reduction starter to engage the engine, and (2) the first control terminal, the second control terminal, the first starter circuit terminal, and the second starter circuit terminal to he plugged into the original manufacturer wiring harness of the vehicle wherein the original manufacturer harness is in the original location of the original manufacturer wiring harness within the vehicle.

In an embodiment, a method for retrofitting a starting system of as vehicle includes a step of removing an original equipment manufacturer (OEM) solenoid of the starting system from an OEM wiring harness of the vehicle. The method also includes plugging into the OEM wiring harness an aftermarket solenoid in place of the OEM solenoid. The aftermarket solenoid may include an electrical switch, an insulating cap, a first control terminal, a second control terminal, a first starter circuit terminal, and a second starter circuit terminal. A control voltage between the first and second control terminals determines resistance path between the first and second starter circuit terminals. The first control terminal may he a first threaded stud protruding through the cap, the second control terminal may be a second threaded stud protruding through the cap, the first starter circuit terminal may he a third threaded stud protruding through the cap, and the second starter circuit terminal may be a fourth threaded stud protruding through the cap. The cap, the first control terminal, the second control terminal, the first starter circuit terminal, and the second starter circuit terminal may be arranged so that the aftermarket solenoid is pluggable into the OEM wiring harness of the vehicle.

These and other features and aspects of selected embodiments inconsistent with the present description will be better understood with reference to the following description, drawings, and appended claims.

### BRIEF DESCRIPTION OF THE INVENTION

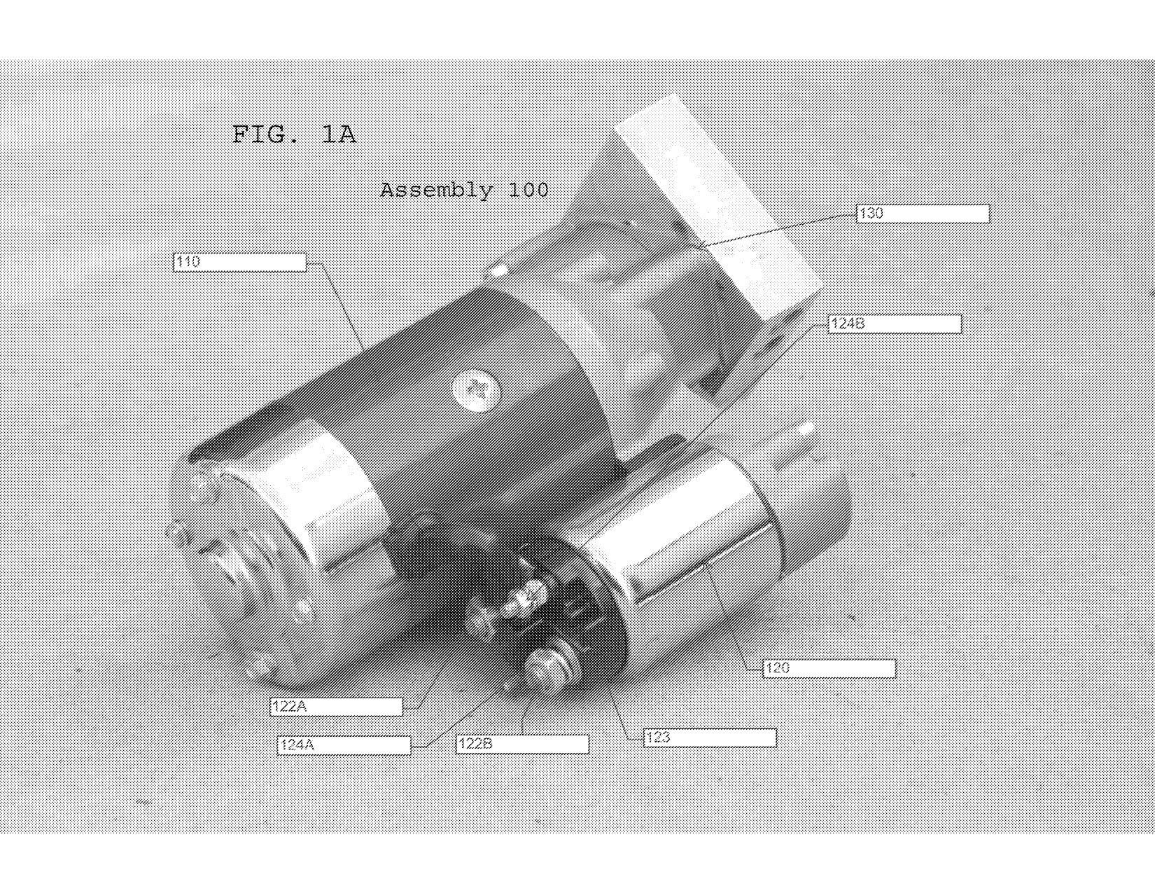

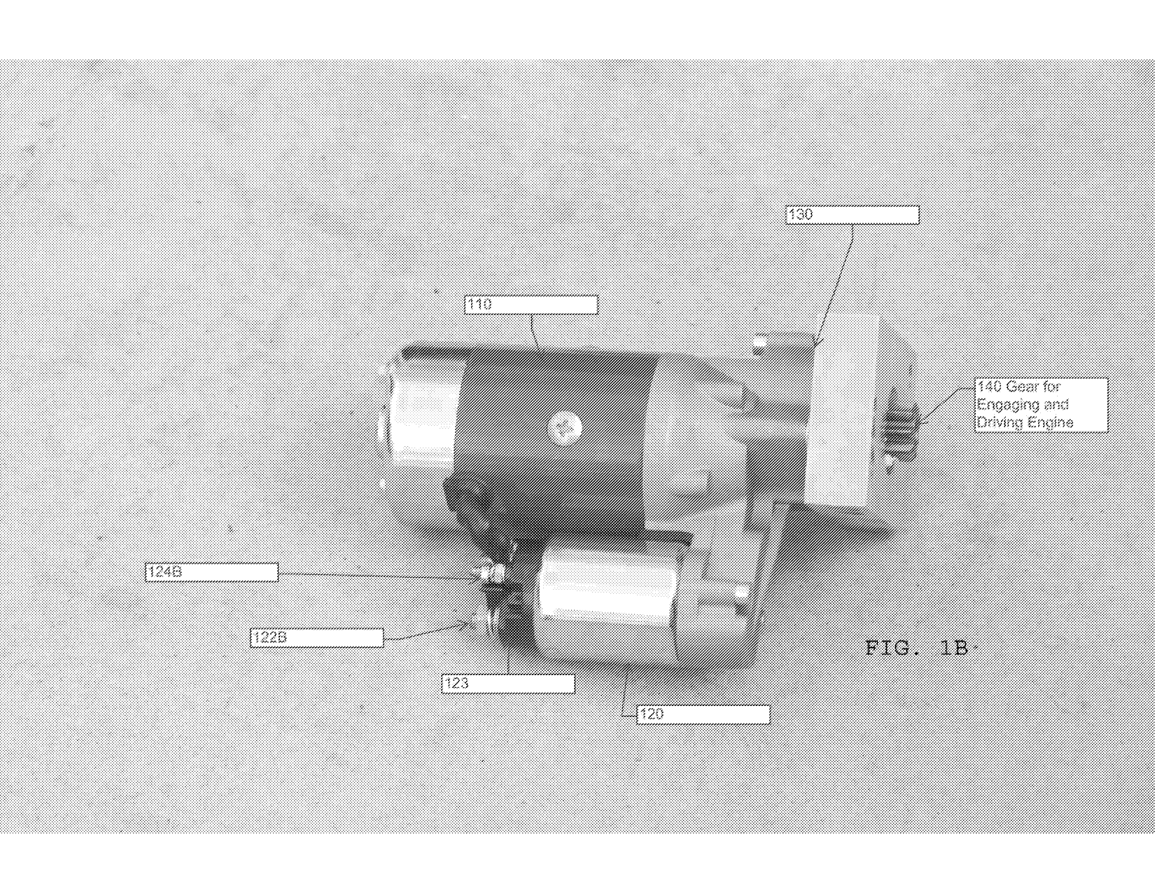

FIGS. 1A, 1B, and 1C illustrate an exemplary starter/solenoid assembly in accordance with selected aspects of the present description;

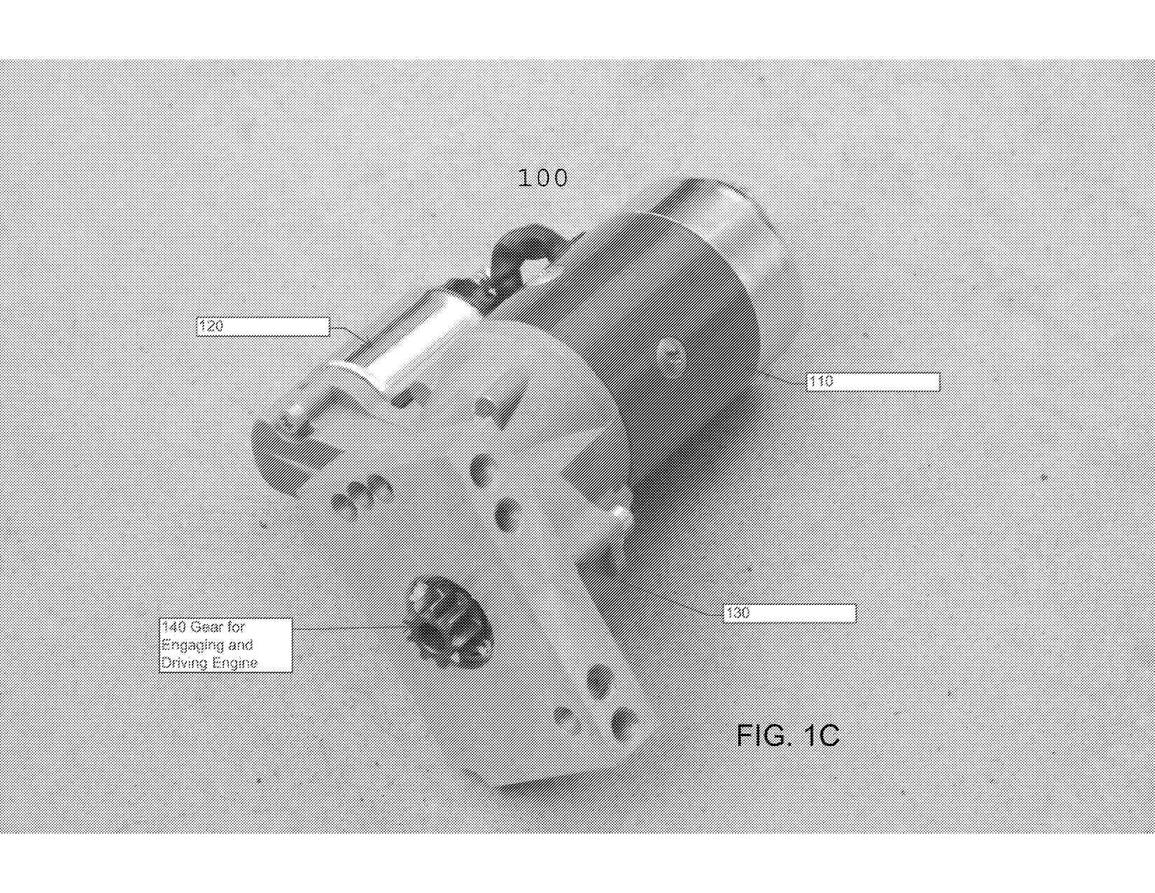

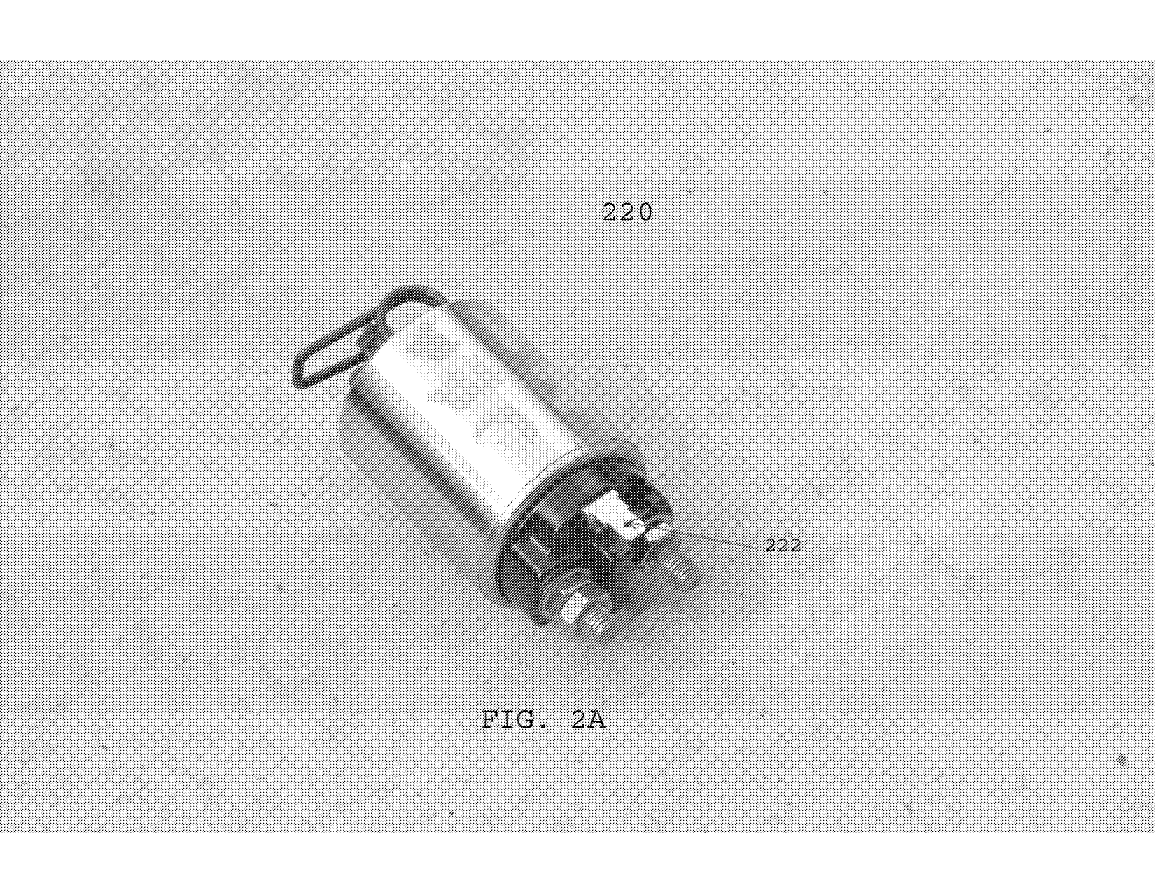

FIGS. 2A and 2B illustrate a solenoid with a spade control terminal; and

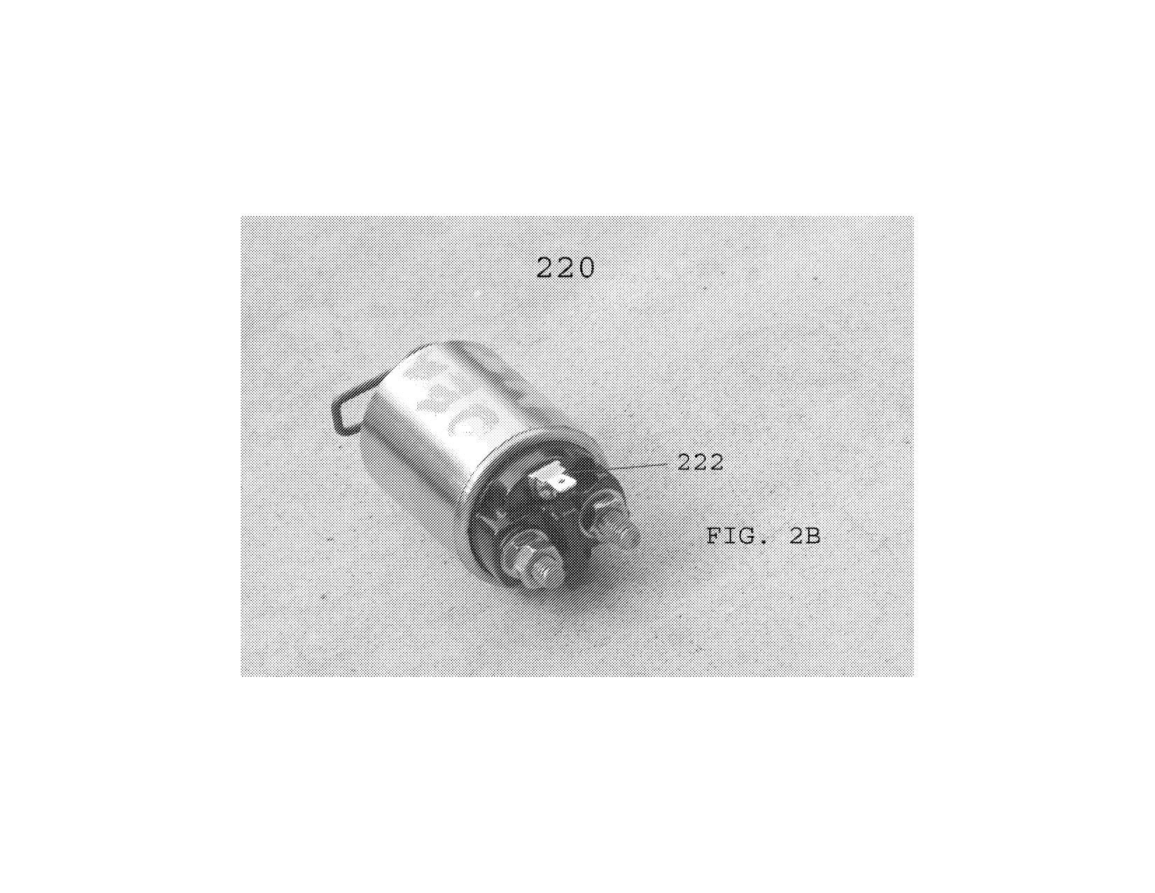

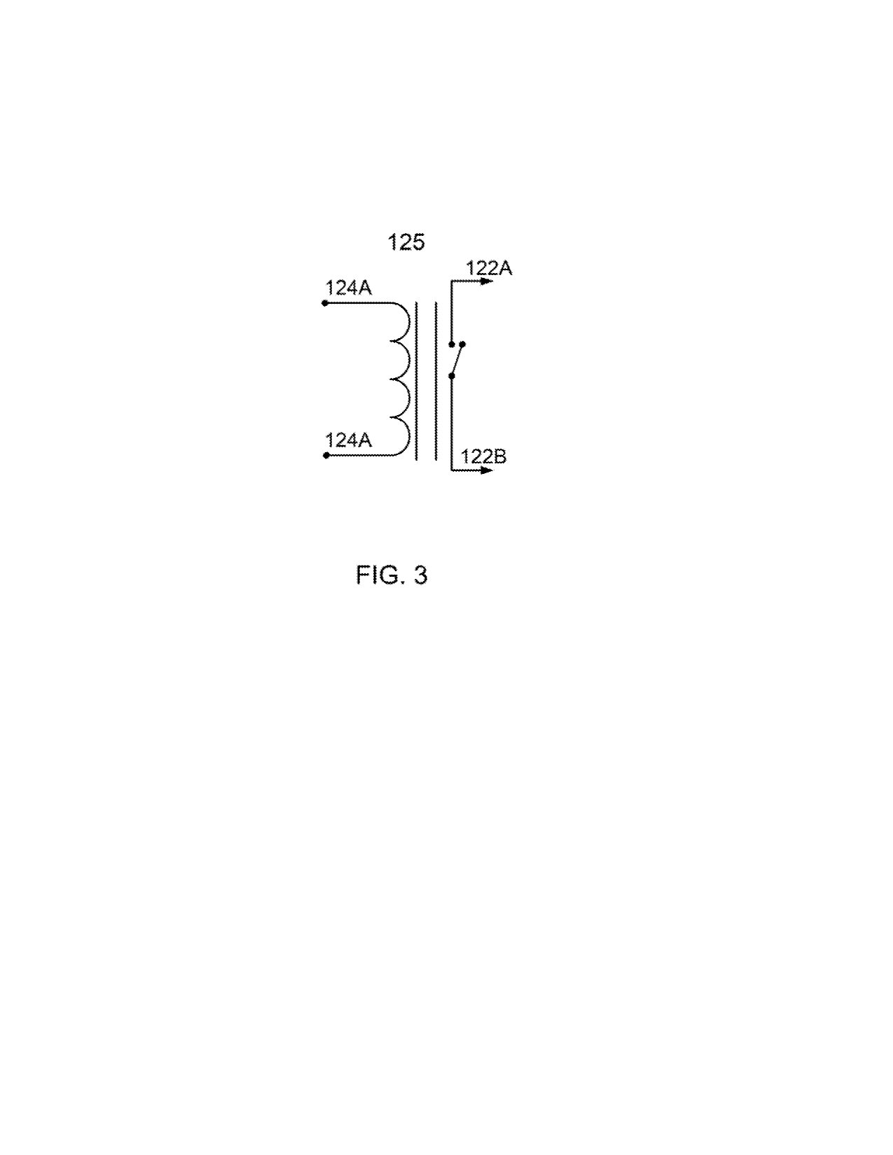

FIG. 3 is a schematic diagram of a starter solenoid.

### DETAILED DESCRIPTION

The starter motors of many vehicles are direct drive motors. For example, United States domestic automobiles through the late 1980s generally used direct drive starters. Often, a user prefers to replace such a starter with a higher performance. garter, Indeed, sometimes a higher performance starter is not a mere preference but a requirement imposed by a high performance engine. A high performance starter may he a geared starter. Hitachi offset gear reduction line of starters presents examples of such high performance starters.

In an example, a Hitachi offset gear reduction starter (“GR starter” in this description and claims) used to replace an OEM non-gear reduction starter. The GR starter is installed in a mounting bracket, which also holds a replacement (e.g., aftermarket) solenoid designed for operation with the GR starter. FIGS. 1A, 1B, and 1C illustrate an exemplary assembly 100 having a GR starter and as replacement solenoid. In the Figures, the starter is designated by numeral 110, the solenoid is designated by numeral 120, and the mounting bracket is designated numeral 130.

The solenoid includes two starter circuit terminals, 122A and 122B, protruding through a solenoid cap 123. The cap 123 may be made of an insulator material, for example, plastic. The starter circuit terminal 122A may be connected, for example, to the battery lead. The starter circuit terminal 122B may be connected to the starter. (This arrangement may be reversed; in any event, once the solenoid creates a low resistance path between the terminals 122A and 122B, current flows through the starter 110.) Each of the starter circuit terminals 122A and 122B may be a threaded stud terminal, for example, a 6 millimeter 1.25 thread terminal (metric), or a 5/16 inch 18 thread terminal (SAE).

The solenoid also includes two control terminals, 124A and 124B. The control terminal 124A may be connected to the ignition lock or the starter button. (Here and elsewhere in this document, “connect” and similar words with their inflectional morphemes refer directly and in directly connected configurations.) The control terminal 124B may be a “resistor” terminal. (Alternatively, the terminal 124A may be the “resistor” terminal and the terminal 124B may be connected to the starter button or ignition switch.) The arrangement is such that the application of a voltage above a predetermined threshold between the control terminals 124A and 124B closes a relay 125 (or other electrical switch) internal to the solenoid 120 and creates a low resistance path between the starter circuit terminals 122A and 122B. In other words, the control terminals 124A and 124B are connected to the primary or control inputs of the electrically-controlled switch of the solenoid 120, and the starter circuit terminals 122A and 122B are connected to the secondary (output) terminals of the switch, as illustrated schematically in FIG. 3. The relay or other switch of the solenoid 120 is typically of the electromechanical type, but may also be made using semiconductor or other technologies.

Note that each of the control terminals 124A and 124B is also a stud terminal, i.e., a threaded stud intended to have a corresponding counterpart ring terminal (connected to a wire) slid on it and fastened with a nut. This is unlike control terminal(s) of known replacement solenoids designed to operate with the Hitachi and other GR starters, which solenoids use spade control terminals, such as the control terminal 222 of a solenoid 220 in FIGS. 2A and 2B. The physical dimensions of the terminals 124A/B (diameter, thread, length, spacing, and/or positioning on the solenoid cap) are such that the control terminals plug directly into the factory (OEM) wiring harness of the vehicle where the assembly 100 is installed. In a particular embodiment, the control terminals are in the 3 and 9 o'clock positions, and the starter circuit terminals are in the 12 and 6 o'clock positions.

The vehicle wiring (or motor) harness typically receives connections such as various engine sensor connections, which may include temperature sending unit, oil pressure sensor, as well as the starter/solenoid connections; in embodiments, the wiring harness may come out of the fuse box in front of the driver position in the passenger compartment, and extend across the top of the firewall and down on the passenger side of the car. The wiring harness may include, for example, ring terminals for receiving and coupling to the starter solenoid control and/or starter circuit terminals. The ring terminals on the wiring harness may be designed to receive the stud terminals such as the terminals 122A/B and 124A/B.

In practice, the starter and the solenoid may be attached to the mounting bracket, thereby forming an assembly, such as the assembly 100 illustrated in FIGS. 1A through 1C. The assembly may then be installed in the engine compartment, with the control terminals and the starter circuit terminals being plugged directly into their corresponding ring terminals in the wiring harness. Because the terminals 122/124 are studs that are substantially the same as the terminals of the OEM solenoid, and the respective dimensions of the mounting bracket 130 and the solenoid 120 are appropriately selected, the installation of the solenoid is simplified. For example, there may be no need to have a makeshift terminal/wire connection from the (previously used) spade terminal to the wiring harness, and no need to modify either the wiring harness of the vehicle or any of the other wiring in the vehicle. In other words, the solenoid can be directly plugged into the OEM harness of the vehicle, while at the same time being attached to the mounting bracket that holds the starter motor in its required position in relation to the engine.

Although steps of various methods may have been described serially in this disclosure, some of these steps may be performed by separate elements in conjunction or in parallel, asynchronously or synchronously, in a pipelined manner, or otherwise. There is no particular requirement that the steps be performed in the same order in which this description lists them, except where explicitly so indicated, otherwise made clear from the context, or inherently required. It should be noted, however, that in selected examples the steps are performed in the specific progressions described in this document and/or shown in the accompanying Figures. Furthermore, not every illustrated step may be required in every system, while some steps that have not been specifically illustrated may be desirable or necessary in some embodiments.

This document describes the inventive apparatus, methods, and articles of manufacture for retrofitting a vehicle with an aftermarket starter solenoid. This was done for illustration purposes. Neither the specific embodiments of the invention as a whole, nor those of its features necessarily limit the general principles underlying the invention. The specific features described herein may be used in some embodiments, but not in others, without departure from the spirit and scope of the invention as set forth herein. Various physical arrangements of components and various step sequences also fall within the intended scope of the invention. Many additional modifications are intended in the foregoing disclosure, and it will be appreciated by those of ordinary skill in the art that in some instances some features of the invention will be employed in the absence of a corresponding use of other features. The illustrative examples therefore do not necessarily define the metes and bounds of the invention. The illustrative example also do not necessarily define the legal protection afforded the invention, which function will be carried out by the issued claims of a non-provisional application, and their equivalents.

What is claimed is:

1. An aftermarket solenoid for a vehicular starting system for a vehicle, the aftermarket solenoid comprising:
an electrical switch;
an insulating cap;
a first control terminal;
a second control terminal;
a first starter circuit terminal; and
a second starter circuit terminal;
wherein:
control voltage between the first and second control terminals determines resistance path between the first and second starter circuit terminals;
the first control terminal comprises a first threaded stud protruding through the cap;
the second control terminal comprises a second threaded stud protruding through the cap;
the first starter circuit terminal comprises a third threaded stud pr wading through the cap;
the second starter circuit terminal comprises a fourth threaded stud protruding through the cap; and
the cap, the first control terminal, the second control terminal, the first starter circuit terminal, and the second starter circuit terminal are arranged so that the solenoid is pluggable into an original equipment manufacturer wiring harness of the vehicle.

2. An aftermarket solenoid as in claim 1, wherein the solenoid is configured to operate an offset gear reduction starter comprising a gear configured to engage selectively an engine of the vehicle.

3. A starter assembly comprising:
a mounting bracket;
the aftermarket solenoid as in claims 2;
the offset gear reduction starter electrically coupled to the aftermarket solenoid so that the in offset gear reduction starter is controlled by the aftermarket solenoid;
wherein the offset gear reduction starter and the aftermarket solenoid are attached to the mounting bracket so that the assembly is configured for installation in the vehicle to allow simultaneously (1) the gear of the offset gear reduction starter to engage the engine, and (2) the first control terminal, the second control terminal, the first starter circuit terminal, and the second is starter circuit terminal to be plugged into the original manufacturer wiring harness of the vehicle wherein the original manufacturer harness is in the original location of the original manufacturer wiring harness within the vehicle.

4. A starter assembly as in claim 3, wherein the offset gear reduction starter is a Hitachi offset gear reduction starter.

5. A method for retrofitting a starting system of a vehicle, the method comprising:
removing an original equipment manufacturer (OEM) solenoid of the starting system from an OEM wiring harness of the vehicle; and
plugging into the OEM wiring harness an aftermarket solenoid in place of the OEM solenoid, the aftermarket solenoid comprising:
an electrical switch;
an insulating cap;
a first control terminal;
a second control terminal;
a first starter circuit terminal; and
a second starter circuit terminal;
wherein:
control voltage between the first and second control terminals determines resistance path between the first and second starter circuit terminals;
the first control terminal comprises a first threaded stud protruding through the cap;
the second control terminal comprises a second threaded stud protruding through the cap;
the first starter circuit terminal comprises a third threaded stud protruding through the cap;
the second starter circuit terminal comprises a fourth threaded stud protruding through the cap; and
the cap, the first control terminal, the second control terminal, the first starter circuit terminal, and the second starter circuit terminal are arranged. so that the aftermarket solenoid is pluggable into the OEM wiring, harness of the vehicle.

6. A method as in claim 5, wherein the aftermarket solenoid is configured to operate an offset gear reduction starter comprising a gear configured to engage selectively an engine of the vehicle.

7. A method as in claim 6, wherein the OEM solenoid is not designed to operate the offset gear in reduction starter.
